(19) United States
(12) Patent Application Publication
(10) Pub. No.: US 2015/0082294 A1
(43) Pub. Date: Mar. 19, 2015

(54) Method and Apparatus for Generating Firmware Over the Air Upgrade Package

(71) Applicant: Huawei Device Co., Ltd., Shenzhen (CN)

(72) Inventor: Deli Tong, Beijing (CN)

(21) Appl. No.: 14/554,431

(22) Filed: Nov. 26, 2014

Related U.S. Application Data
(63) Continuation of application No. PCT/CN2013/076303, filed on May 28, 2013.

(30) Foreign Application Priority Data
May 28, 2012 (CN) 201210169141.7

(51) Int. Cl. G06F 9/445; H04L 29/08

(52) U.S. Cl. CPC G06F 8/65; H04L 67/10
USPC 717/170

(57) ABSTRACT

Embodiments of the present invention provide a method and an apparatus for generating a FOTA upgrade package, a software upgrade method, and a mobile terminal. The method for generating a FOTA upgrade package includes: generating transition software according to comparison of file names and file binary formats of software of two to-be-upgraded versions among at least two to-be-upgraded versions; and generating a FOTA upgrade package according to comparison of file names and file binary formats between the transition software and final-version software. Using the foregoing technical solutions, a software version provider may use a same FOTA upgrade package to upgrade a plurality of early versions, which meets a requirement of upgrading a plurality of early versions of different mobile users to a latest version by using a same FOTA upgrade package, and reduces development and maintenance costs for the software version provider at the same time.

### CROSS-REFERENCE TO RELATED APPLICATIONS

This application is a continuation of International Application No. PCT/CN2013/076303, filed on May 28, 2013, which claims priority to Chinese Patent Application No. 201210169141.7, filed on May 28, 2012, both of which are hereby incorporated by reference in their entireties.

### TECHNICAL FIELD

The present invention relates to the field of wireless communications, and more specifically, to a method and an apparatus for generating a firmware over the air (FOTA for short) upgrade package.

### BACKGROUND

Rapidly changing mobile terminals emerge with technology development. To satisfy people's pursuit of novelties, functions of the mobile terminals are constantly extended. An excessively early software version of a mobile terminal may affect use of new functions; therefore, update online functions become more popular. A FOTA upgrade online function is used to upgrade a mobile terminal from an earlier version to a later version over the air. A conventional production manner is to produce a FOTA upgrade package in accordance with a difference between an early version and a later version, so that a user can download the upgrade package from a network and use the upgrade package to upgrade a mobile terminal. Generally, 2 to 3 versions are maintained for a mobile terminal, and for a mobile terminal that is generally applicable overseas, there are versions of more stages for different countries. In the prior art, if it needs to be satisfied that mobile terminals using different software versions is upgraded from an early version to a latest version, a software version provider, such as a mobile terminal manufacturer or an operator, needs to produce a FOTA upgrade package for each early version, which increases software development time and maintenance costs, thereby greatly increasing operation costs.

### SUMMARY

Embodiments of the present invention provide a method and an apparatus for generating a FOTA upgrade package, a software upgrade method, and a mobile terminal, which can reduce operation costs.

According to one aspect, a method for generating a firmware over the air (FOTA) upgrade package is provided and includes: generating transition software according to comparison of file names and file binary formats of software of two to-be-upgraded versions among at least two to-be-upgraded versions; and generating a FOTA upgrade package according to comparison of file names and file binary formats between the transition software and final-version software.

According to another aspect, an apparatus for generating a firmware over the air (FOTA) upgrade package is provided and includes: a first generating unit, configured to generate transition software according to comparison of file names and file binary formats of software of two to-be-upgraded versions among at least two to-be-upgraded versions; and a second generating unit, configured to generate a FOTA upgrade package according to comparison of file names and file binary formats between the transition software generated by the first generating unit and final-version software, where the FOTA upgrade package is used to simultaneously support online upgrade of the software of the two to-be-upgraded versions to the final-version software by using a wireless network.

According to another aspect, a software upgrade method is provided and includes: acquiring a firmware over the air (FOTA) upgrade package generated by using the foregoing method, and using the FOTA upgrade package to upgrade a software system of a mobile terminal.

According to another aspect, a mobile terminal is provided and includes an acquiring unit and an upgrading unit, where the acquiring unit is configured to acquire a firmware over the air (FOTA) upgrade package generated according to the foregoing method, and the upgrading unit is configured to upgrade a software system of the mobile terminal by using the FOTA upgrade package.

The foregoing technical solutions provide a method and an apparatus for generating a FOTA upgrade package, so that a software version provider may use a same FOTA upgrade package to upgrade a plurality of early versions, which meets a requirement of upgrading a plurality of early versions of different mobile users to a latest version by using a same FOTA upgrade package, and reduces development and maintenance costs for the software version provider at the same time.

### BRIEF DESCRIPTION OF DRAWINGS

To describe the technical solutions in the embodiments of the present invention more clearly, the following briefly introduces the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is schematic block diagram of a method for generating a FOTA upgrade package according to an embodiment of the present invention;

FIG. 2 is schematic block diagram of a method for generating a FOTA upgrade package according to another embodiment of the present invention;

FIG. 3A is schematic block diagram of an apparatus for generating a FOTA upgrade package according to an embodiment of the present invention;

FIG. 3B is schematic block diagram of an apparatus for generating a FOTA upgrade package according to another embodiment of the present invention;

FIG. 4 is a schematic flowchart of a software upgrade method according to an embodiment of the present invention;

FIG. 5 is a schematic flowchart of a software upgrade method according to another embodiment of the present invention; and

FIG. 6A and FIG. 6B are schematic block diagrams of a mobile terminal according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

An embodiment of the present invention provides a method for generating a FOTA upgrade package, so that a software version provider may use a same FOTA upgrade package to upgrade a plurality of early versions.

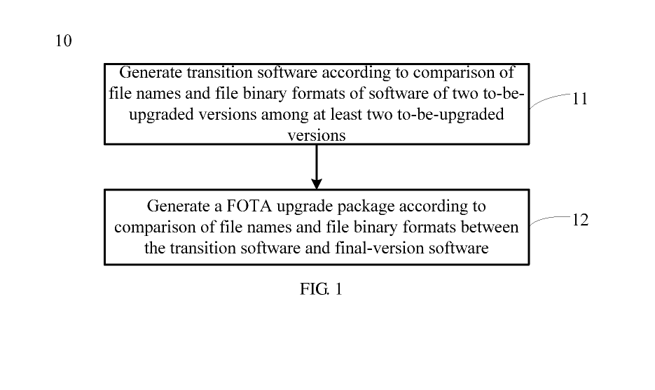

FIG. 1 is schematic block diagram of a method 10 for generating a FOTA upgrade package according to the embodiment of the present invention.

11: Generate transition software according to comparison of file names and file binary formats of software of two to-be-upgraded versions among at least two to-be-upgraded versions.

12: Generate a FOTA upgrade package according to comparison of file names and file binary formats between the transition software and final-version software.

The embodiment of the present invention provides a method for generating a FOTA upgrade package, so that a software version provider may use a same FOTA upgrade package to upgrade a plurality of early versions, which meets a requirement of upgrading a plurality of early versions of different mobile users to a latest version by using a same FOTA upgrade package, and reduces development and maintenance costs for the software version provider at the same time.

Optionally, the generating transition software according to comparison of file names and file binary formats of software of two to-be-upgraded versions among at least two to-be-upgraded versions specifically includes: comparing the software of the two to-be-upgraded versions; saving files, which have a same file name and are in a same binary format, as a common file of the transition software; saving files, which have different file names or a same file name and are in different binary formats, as differentiation files of the transition software; and generating the transition software according to the common file of the transition software and the differentiation files of the transition software.

Optionally, the saving files, which have different file names or a same file name and are in different binary formats, as differentiation files of the transition software specifically includes: when the final-version software includes a file with the same name as the files, in the software of the two to-be-upgraded versions, that have the same file name but are in different binary formats, excluding the files, which have the same file name but are in different binary formats, from the differentiation files of the transition software (that is, the files are not included in the differentiation files of the transition software); when the final-version software does not include a file with the same name as the files, in the software of the two to-be-upgraded versions, that have the same file name but are in different binary formats, retaining the files, which have the same file name but are in different binary formats, in the differentiation files of the transition software; when the software of one to-be-upgraded version has a file excluded from the software of the other to-be-upgraded version (hereafter the file excluded from the software of the other to-be-upgraded version is called as “excluded file”, which means the software of one to-be-upgraded version has a file that the software of the other to-be-upgraded version does not include), and a file with a same name as the excluded file is included in the final-version software, excluding the file from the differentiation files of the transition software (that is, the excluded file is not included in the differentiation files of the transition software); when the software of one to-be-upgraded version has a file excluded from the software of the other to-be-upgraded version, and a file with a same name as the excluded file is not included in the final-version software, retaining the file in the differentiation files of the transition software.

Optionally, the generating a FOTA upgrade package according to comparison of file names and file binary formats between the transition software and final-version software specifically includes: comparing the transition software and the final-version software; saving a file, which is included in the final-version software and is not included in the transition software, as an overwrite file of the FOTA upgrade package; saving different parts of the files, which have the same file name but are in different binary formats, as a difference file of the FOTA upgrade package; and generating an upgrade software package according to the overwrite file and the difference file of the FOTA upgrade package.

Optionally, the generating a FOTA upgrade package according to comparison of file names and file binary formats between the transition software and final-version software further includes: saving an upgrade package of a secure digital memory card of the final-version software as an upgrade file of the FOTA upgrade package. Correspondingly, the generating the transition software according to the overwrite file and the difference file of the FOTA upgrade package specifically includes: generating the FOTA upgrade package according to the upgrade file, the overwrite file, and the difference file of the FOTA upgrade package.

Optionally, the generating a FOTA upgrade package according to comparison of file names and file binary formats between the transition software and final-version software further includes: writing a file, which is included in the transition software and is not included in the final-version software, into an upgrade script of the FOTA upgrade package as a to-be-deleted file, so as to delete the to-be-deleted file by using a script command in an upgrade process.

Optionally, when the software of the two to-be-upgraded versions is first-version software and second-version software, transition software, namely, first transition software, is generated according to comparison of the first-version software and the second-version software. A FOTA upgrade package, namely, a first FOTA upgrade package, is generated according to comparison of file names and file binary formats between the first transition software and the final-version software, where the first FOTA upgrade package is used to simultaneously support online upgrade of the software of the two to-be-upgraded versions, namely, the first-version software and the second-version software, to the final-version software by using the wireless network.

Optionally, when software of more than two to-be-upgraded versions is included, and there are K+2 to-be-upgraded versions, where K is a positive integer, K+1^{th} transition software is generated according to comparison of file names and file binary formats between K+2^{th}-version software and K^{th} transition software, where K is the positive integer; a K+1^{th} FOTA upgrade package is generated according to comparison of file names and file binary formats between the K+1^{th} transition software and the final-version software, where the K+1^{th} FOTA upgrade package is used to simultaneously support online upgrade of software of the K+2 to-be-upgraded versions to the final-version software by using the wireless network.

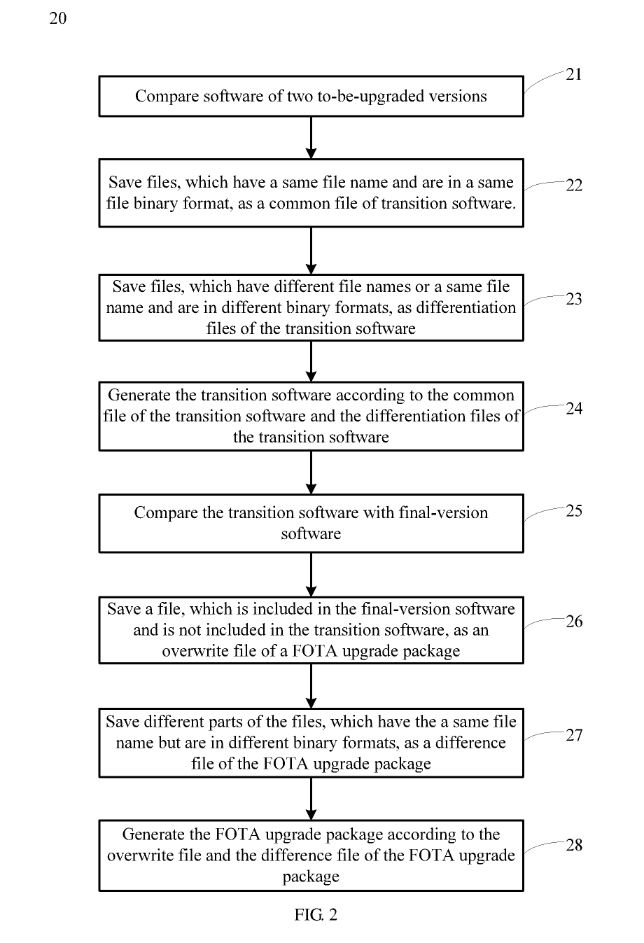

FIG. 2 is schematic block diagram of a method 20 for generating a FOTA upgrade package according to another embodiment of the present invention.

21: Compare software of two to-be-upgraded versions.

If a FOTA upgrade package is used to upgrade a plurality of early versions, definitely there are differences between the plurality of early versions. These differences include the following three cases. To simplify description in the following, the embodiment of the present invention uses two to-be-upgraded early versions as an example. First-version software is referred to as an a1 version hereinafter, and second-version software is referred to as an a2 version hereinafter. Transition software that is generated based on the a1 version and the a2 version is referred to as a b1 version hereinafter. Final-version software is referred to as a c 1 version hereinafter, and the final-version software is a version to which the a1 version and the a2 version are finally upgraded.

case (1) The a1 and a2 versions include files that have a same file name and a same binary file.

case (2) The a1 and a2 versions include files that have a same file name but different binary files.

case (3) The a1 or a2 version includes a file that is not included in the other version, where the file is a file excluded from one of the two versions, and a file name of the file appears only in one of the two versions.

22: Save files, which have a same file name and are in a same file binary format, as a common file of transition software.

For case (1), same files in the two early versions are retained in the b1 version.

Therefore, a structure of the same files in the different early versions is not damaged in the b1 version. In this way, the FOTA upgrade package generated according to the b1 version can also ensure normal upgrade of these files.

23: Save files, which have different file names or a same file name and are in different binary formats, as differentiation files of the transition software.

For case (2), processing varies according to a situation in the c1 version. If the c1 version also includes a file with the same name as the foregoing files, the files are deleted from the b1 version, so that this type of file is upgraded in an overwriting manner after the FOTA upgrade package is produced. If the c1 version does not include such a file, the file with the same name in the a1 or a2 version is retained in the b1 version, so that the file is deleted by using a script after the FOTA upgrade package is produced, thereby ensuring that upgraded versions are consistent.

During an upgrade of a software version, a purpose of overwriting or deleting the file according to the FOTA upgrade package generated according to the b1 version is achieved by the following: using a file newly added in the c1 after the c1 and b1 are compared for copying and overwriting, and deleting a file by using a script.

For case (3), processing is similar to that of case (2). When the a1 or a2 version includes a file that does not exist in the other version, where the file that does not exist may be: after the a1 version and the a2 version are compared, a file included in the a1 version a1 but not included in the a2 version, or a file included in the a2 version but not included in the a1 version, that is, a file that is excluded from one of the a1 version and the a2 version, if this file exists in the c1 version, the file is deleted from the b1 version, so that this type of file is upgraded in an overwriting manner after the FOTA upgrade package is produced; if this file does not exist in the c1 version, the file is included in the b1 version, so that the file is deleted by using a script after the FOTA upgrade package is produced, thereby ensuring that upgraded versions are consistent.

24: Generate the transition software according to the common file of the transition software and the differentiation files of the transition software.

25: Compare the transition software with final-version software.

Similar to comparison of the software of the two early versions, the following cases may occur when the transition software version b1 is compared with the final-version software version c1.

case (4) The b1 and c1 versions include files with a same file name.

case (5) The c1 version includes a file that is not included in the b1 version.

case (6) The b1 version includes a file that is not included in the c1 version.

26: Save a file, which is included in the final-version software and is not included in the transition software, as an overwrite file of a FOTA upgrade package.

For case (5), the file included in the c1 and not included in the b1 is saved, in a form of an original file, in a root directory of the FOTA upgrade package according to a directory structure of the file in a mobile terminal and serves as the overwrite file of the FOTA upgrade package. The file included in the c1 and not included in the b1 may be a file with a same name as a file that is included in the a1 version but not included in the a2 version, may also be a file with a same name as a file that is included in the a2 version but not included in the a1 version, may also be a file with a same name as files that are included in the a1 and a2 versions, which have the same name but are in different binary formats, and may further be a file not included in either the a1 version or the a2 version.

27: Save different parts of the files, which have the same file name but are in different binary formats, as a difference file of the FOTA upgrade package.

For case (4), binary comparison is performed on the files with the same name in the b1 and c1 versions. When binary formats of the files with the same name are the same, the files are not included in the FOTA upgrade package. When binary formats of the files with the same name are different, a difference file is generated based on different parts and saved in a patch (patch) directory of the FOTA upgrade package.

28: Generate the FOTA upgrade package according to the overwrite file and the difference file of the FOTA upgrade package.

Optionally, for case (6), the extra file in the b1 version, that is, the file that does not exist in the c1 version, is written into an upgrade script, and the file is deleted by using a script command in an upgrade process. Particularly, deleting a file from the FOTA upgrade package is directly deleting the file by using a shell command in the script. If the file does not exist in the b1 version, no impact is exerted. In this way, a size of the generated FOTA upgrade package is further decreased, thereby improving efficiency of an upgrade over the air.

In addition, same as the prior art, the FOTA upgrade package further includes an upgrade package of a secure digital memory card (SD card for short) of the c1 version. The upgrade package of the SD card may be saved in the root directory of the FOTA upgrade package.

Software of a transition version is obtained by merging the two early versions and then is compared with the final-version software for generating the FOTA upgrade package, which can achieve a purpose of upgrading a plurality of early versions by using a same FOTA upgrade package. In addition, a size of the FOTA upgrade package is decreased as much as possible by using the foregoing method for generating a FOTA upgrade package, which helps a mobile user to acquire the FOTA upgrade package over the air.

Optionally, if there are more than two early versions, for example, further including a third software version (also referred to as an a3 version) and a fourth software version (also referred to as an a4 version), steps 21 to 24 in the foregoing method are executed repeatedly to merge the b1 version and the a3 version to obtain a transition software version b2, and merge the b2 version and the a4 version to obtain a later transition software version b3, and so on. Then, steps 25 to 28 in the foregoing method are executed to generate a FOTA upgrade package according to last transition software and the final-version software version c1. By using the foregoing method, the generated FOTA upgrade package can meet a requirement of upgrading mobile terminals of different versions, thereby saving labor costs for a software version provider, and saving costs of part of hardware used for storage.

In addition, further, when the software version provider provides a version later than the final-version software version c1, for example, a c2 version, a FOTA upgrade package is generated according to the c1 version and the c2 version by executing steps 25 to 28 in the foregoing method. By always maintaining one FOTA upgrade package, labor costs are saved for the software version provider, and costs of part of hardware used for storage are saved.

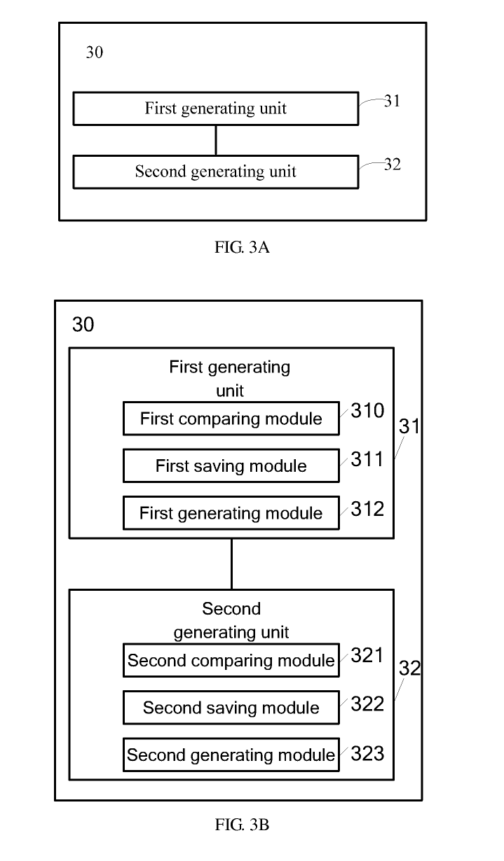

FIG. 3A and FIG. 3B are schematic block diagrams of an apparatus 30 for generating a FOTA upgrade package according to an embodiment of the present invention. The apparatus 30 includes a first generating unit 31 and a second generating unit 32.

The first generating unit 31 is configured to generate transition software according to comparison of file names and file binary formats of software of two to-be-upgraded versions among at least two to-be-upgraded versions.

The second generating unit 32 is configured to generate a FOTA upgrade package according to comparison of file names and file binary formats between the transition software generated by the first generating unit and final-version software, where the FOTA upgrade package is used to simultaneously support online upgrade of the software of the two to-be-upgraded versions to the final-version software by using a wireless network.

The embodiment of the present invention provides an apparatus for generating a FOTA upgrade package, so that a software version provider may use a same FOTA upgrade package to upgrade a plurality of early versions, which meets a requirement of upgrading a plurality of early versions of different mobile users to a latest version by using a same FOTA upgrade package, and reduces development and maintenance costs for the software version provider at the same time.

Optionally, as shown in FIG. 3B, the first generating unit 31 of the apparatus 30 specifically includes a first comparing module 310, a first saving module 311, and a first generating module 312.

The first comparing module is configured to compare the software of the two to-be-upgraded versions.

The first saving module is configured to save files, which have a same file name and are in a same file binary format, as a common file of the transition software; and is further configured to save files, which have different file names or a same file name and are in different binary formats, as differentiation files of the transition software.

The first generating module is configured to generate the transition software according to the common file of the transition software and the differentiation files of the transition software that are saved by the first saving module.

Optionally, the first saving module is specifically configured to: when the final-version software includes a file with the same name as the files, in the software of the two to-be-upgraded versions, that have the same file name but are in different binary formats, exclude the files, which have the same file name but are in different binary formats, from the differentiation files of the transition software; when the final-version software does not include a file with the same name as the files, in the software of the two to-be-upgraded versions, that have the same file name but are in different binary formats, retain the files, which have the same file name but are in different binary formats, in the differentiation files of the transition software; when the software of one to-be-upgraded version has a file excluded from the software of the other to-be-upgraded version, and a file with a same name as the excluded file is included in the final-version software, exclude the file from the differentiation files of the transition software; when the software of one to-be-upgraded version has a file excluded from the software of the other to-be-upgraded version, and a file with a same name as the excluded file is not included in the final-version software, retain the file in the differentiation files of the transition software.

Optionally, as shown in FIG. 3B, the second generating unit 32 of the apparatus 30 specifically includes a second comparing module 320, a second saving module 321, and a second generating module 322.

The second comparing module is configured to compare the transition software and the final-version software.

The second saving module is configured to save a file, which is included in the final-version software and is not included in the transition software generated by the second comparing module, as an overwrite file of the FOTA upgrade package; and is further configured to save different parts of the files, which have the same file name but are in different binary formats, as a difference file of the FOTA upgrade package.

The second generating module is configured to generate the firmware software package according to the overwrite file and the difference file of the FOTA upgrade package that are saved by the second saving module.

Optionally, the second saving module is further configured to save an upgrade package of a secure digital memory card of the final-version software as an upgrade file of the FOTA upgrade package. Correspondingly, the second generating module is specifically configured to generate the FOTA upgrade package according to the upgrade file, the overwrite file, and the difference file of the FOTA upgrade package that are saved by the second saving module.

Optionally, the first generating module is further configured to write a file, which is included in the transition software and is not included in the final-version software, into an upgrade script of the FOTA upgrade package as a to-be-deleted file, so as to delete the to-be-deleted file by using a script command in an upgrade process.

Optionally, when the software of the two to-be-upgraded versions is first-version software and second-version software, the apparatus is specifically configured to: the first generating unit specifically generates transition software, namely, first transition software, according comparison of the first-version software and the second-version software, and the second generating unit generates a FOTA upgrade package, namely, a first FOTA upgrade package, according to comparison of file names and file binary formats between the first transition software generated by the first generating unit and the final-version software, where the first FOTA upgrade package is used to simultaneously support online upgrade of the software of the two to-be-upgraded versions, namely, the first-version software and the second-version software, to the final-version software by using the wireless network.

Optionally, the apparatus is further configured to: when software of more than two to-be-upgraded versions is included, and there are K+2 to-be-upgraded versions, where K is a positive integer, the first generating unit is specifically configured to generate K+1^{th} transition software according to comparison of file names and file binary formats between K+2^{th}-version software and K^{th} transition software, where K is the positive integer; and the second generating unit is specifically configured to generate a K+1^{th} FOTA upgrade package according to comparison of file names and file binary formats between the K+1^{th} transition software generated by the first generating unit and the final-version software, where the K+1^{th} FOTA upgrade package is used to simultaneously support online upgrade of software of the K+2 to-be-upgraded versions to the final-version software by using the wireless network.

The apparatus 30 implements the foregoing method 10 and/or 20, and for brevity, specific details are not described herein again.

The embodiment of the present invention provides an apparatus for generating a FOTA upgrade package, so that a software version provider may use a same FOTA upgrade package to upgrade a plurality of early versions, which meets a requirement of upgrading a plurality of early versions of different mobile users to a latest version by using a same FOTA upgrade package, and reduces development and maintenance costs for the software version provider at the same time.

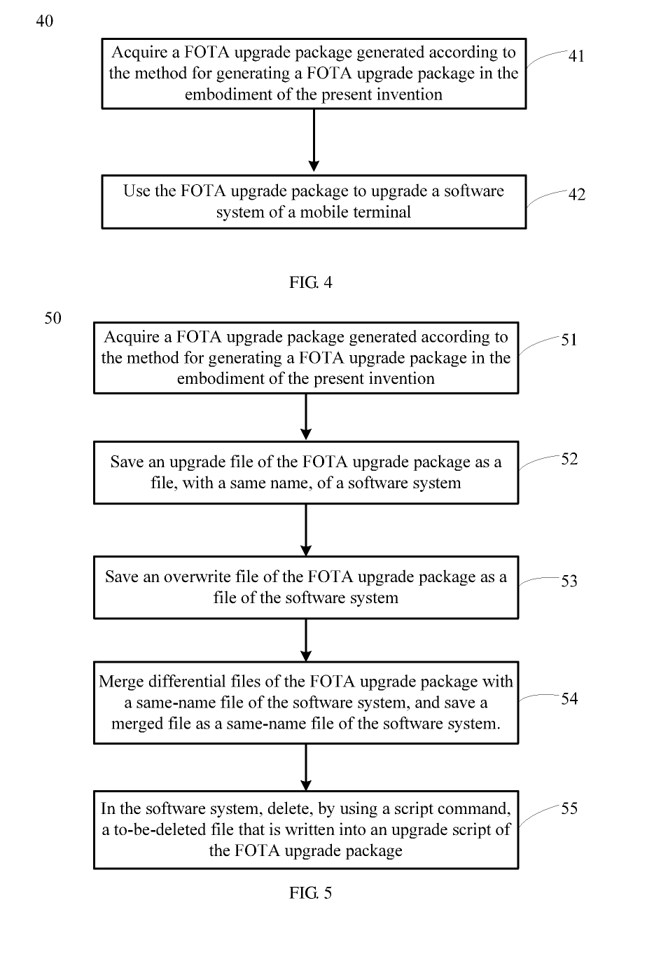

In the following, by using a FOTA upgrade package generated by the foregoing method and apparatus for generating a FOTA upgrade package, FIG. 4 shows a schematic flowchart of a software upgrade method 40 according to an embodiment of the present invention. The method 40 includes the following steps:

41: Acquire the FOTA upgrade package generated according to the method for generating a FOTA upgrade package in the embodiment of the present invention.

42: Use the FOTA upgrade package to upgrade a software system of a mobile terminal.

The embodiment of the present invention provides a software upgrade method, so that a plurality of early versions of mobile users can be upgraded to a latest version by using one FOTA upgrade package; and a reduced size of the FOTA upgrade package helps the mobile users to acquire the FOTA upgrade package.

FIG. 5 is a schematic flowchart of a software upgrade method 50 according to another embodiment of the present invention. The method 50 includes the following content:

51: Acquire the FOTA upgrade package generated according to the method for generating a FOTA upgrade package in the embodiment of the present invention.

A mobile terminal acquires, over the air, the FOTA upgrade package generated in the foregoing embodiment. An acquiring manner is the same as that in the prior art. For the method for generating the FOTA upgrade package, reference is made to, for example, the embodiment in FIG. 2. In this embodiment, the generated FOTA upgrade package includes an upgrade file, an overwrite file, and a difference file.

52: Save an upgrade file of the FOTA upgrade package as a file, with a same name, of a software system.

It can be known, from the embodiment of generating the FOTA upgrade package, that an upgrade package of a secure digital memory card of the final-version software is saved as the upgrade file of the FOTA upgrade package.

53: Save an overwrite file of the FOTA upgrade package as a file of the software system.

It can be known, from the embodiment of generating the FOTA upgrade package, that a file included in the final-version software but not included in transition software is saved as an overwrite file of the FOTA upgrade package. A method for upgrading this type of file is to directly overwrite the files over an original version. This type of file can be separately saved as a complete file in the upgrade package.

54: Merge a difference file of the FOTA upgrade package with a same-name file of the software system, and save a merged file as a same-name file of the software system.

It can be known, from the embodiment of generating the FOTA upgrade package, that different parts of files, which have a same file name and are in different binary formats and are in the transition software and the final-version software, are saved as a difference file of the FOTA upgrade package.

55: In the software system, delete, by using a script command, a to-be-deleted file that is written into an upgrade script of the FOTA upgrade package.

It can be known, from the embodiment of generating the FOTA upgrade package, that a file that is included in the transition software but is not included in the final-version software is written into the upgrade script of the FOTA upgrade package as a to-be-deleted file.

The embodiment of the present invention provides a software upgrade method, so that a plurality of early versions of mobile users can be upgraded to a latest version by using a FOTA upgrade package generated in another embodiment of the present invention; a reduced size of the FOTA upgrade package helps the mobile users to acquire the FOTA upgrade package.

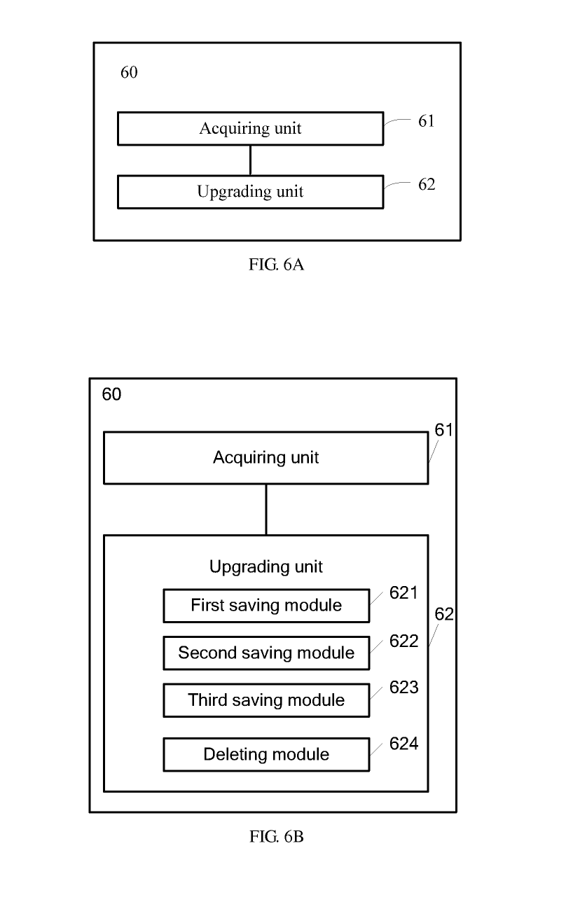

FIG. 6A is a schematic block diagram of a mobile terminal 60 according to an embodiment of the present invention, where the mobile terminal 60 includes an acquiring unit 61 and an upgrading unit 62.

The acquiring module 61 is configured to acquire a firmware over the air FOTA upgrade package generated according to the method for generating a FOTA upgrade package in the embodiment of the present invention.

The upgrading unit 62 is configured to upgrade a software system of the mobile terminal by using the FOTA upgrade package.

The embodiment of the present invention provides a software upgrade apparatus, so that a plurality of early versions of mobile users can be upgraded to a latest version by using a FOTA upgrade package generated in another embodiment of the present invention, which helps the mobile users to acquire the FOTA upgrade package.

Optionally, as shown in FIG. 6B, the upgrading unit 62 specifically includes: a first saving module 621, a second saving module 622, and a third saving module 623.

When the FOTA upgrade package includes an upgrade file, an overwrite file, and a difference file, the first saving module 621 saves the upgrade file of the FOTA upgrade package as a file, with a same name, of the software system; the second saving module 622 saves the overwrite file of the FOTA upgrade package as a file of the software system; and the third saving module 623 merges the difference file of the FOTA upgrade package with the same-name file of the software system, and saves a merged file as a same-name file of the software system.

The upgrading unit further includes a deleting module 624. The deleting module 624 deletes, from the software system by using a script command, a to-be-deleted file that is written into an upgrade script of the FOTA upgrade package.

The mobile terminal 60 implements the method 40 and/or 50. For brevity, specific details are omitted herein. A mobile terminal, also referred to as a user equipment (UE), a mobile user equipment, and the like, may communicate with one or more core networks through a radio access network (for example, RAN). The user equipment may be a mobile terminal, such as a mobile phone (also referred to as a “cellular” phone) and a computer with a mobile terminal. For example, the user equipment may be a portable, pocket-sized, handheld, computer built-in, or in-vehicle mobile apparatus, which exchanges language and/or data with the radio access network.

The embodiment of the present invention provides a software upgrade apparatus, so that a plurality of early versions of mobile users can be upgraded to a latest version by using a FOTA upgrade package generated in another embodiment of the present invention; a reduced size of the FOTA upgrade package helps the mobile users to acquire the FOTA upgrade package.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of the present invention essentially, or the part contributing to the prior art, or a part of the technical solutions may be implemented in a form of a software product. The software product is stored in a storage medium, and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for generating a FOTA (firmware over the air) upgrade package, comprising:
generating transition software according to comparison of file names and file binary formats of software of two to-be-upgraded versions; and
generating a FOTA upgrade package according to comparison of file names and file binary formats between the transition software and final-version software, wherein the FOTA upgrade package is used to simultaneously support online upgrade of the software of the two to-be-upgraded versions to the final-version software by using a wireless network.

2. The method according to claim 1, wherein the generating transition software according to comparison of file names and file binary formats of software of two to-be-upgraded versions specifically comprises:
comparing the software of the two to-be-upgraded versions;
saving files, which have a same file name and are in a same file binary format, as a common file of the transition software;
saving files, which have different file names or which have a same file name and are in different binary formats, as differentiation files of the transition software; and
generating the transition software according to the common file of the transition software and the differentiation files of the transition software.

3. The method according to claim 2, wherein the saving files, which have different file names or which have a same file name and are in different binary formats, as differentiation files of the transition software specifically comprises:
when the final-version software comprises a file with the same name as the files, in the software of the two to-be-upgraded versions, that have the same file name but are in different binary formats, excluding the files, which have the same file name but are in different binary formats, from the differentiation files of the transition software;
when the final-version software does not comprise a file with the same name as the files, in the software of the two to-be-upgraded versions, that have the same file name but are in different binary formats, retaining the files, which have the same file name but are in different binary formats, in the differentiation files of the transition software;
when the software of one to-be-upgraded version has a file excluded from the software of the other to-be-upgraded version, and a file with a same name as the excluded file is comprised in the final-version software, excluding the file from the differentiation files of the transition software; and
when the software of one to-be-upgraded version has a file excluded from the software of the other to-be-upgraded version, and a file with a same name as the excluded file is not comprised in the final-version software, retaining the file in the differentiation files of the transition software.

4. The method according to claim 1, wherein the generating a FOTA upgrade package according to comparison of file names and file binary formats between the transition software and final-version software specifically comprises:
comparing the transition software and the final-version software;
saving a file, which is comprised in the final-version software and is not comprised in the transition software, as an overwrite file of the FOTA upgrade package;
saving different parts of the files, which have the same file name but are in different binary formats, as a difference file of the FOTA upgrade package; and
generating the FOTA upgrade package according to the overwrite file and the difference file of the FOTA upgrade package.

5. The method according to claim 4, wherein the generating a FOTA upgrade package according to comparison of file names and file binary formats between the transition software and final-version software further comprises:
saving a data of a secure digital memory card of the final-version software as an upgrade file of the FOTA upgrade package; and
correspondingly generating the FOTA upgrade package according to the upgrade file, the overwrite file, and the difference file of the FOTA upgrade package.

6. The method according to claim 5, wherein the generating a FOTA upgrade package according to comparison of file names and file binary formats between the transition software and final-version software further comprises:
writing a file, which is comprised in the transition software and is not comprised in the final-version software, into an upgrade script of the FOTA upgrade package as a to-be-deleted file, so as to delete the to-be-deleted file by using a script command in an upgrade process.

7. The method according to claim 1, wherein the method specifically comprises:
when the software of the two to-be-upgraded versions is first-version software and second-version software, generating transition software, namely, first transition software, according to comparison of the first-version software and the second-version software, and generating a FOTA upgrade package, namely, a first FOTA upgrade package, according to comparison of file names and file binary formats between the first transition software and the final-version software, wherein the first FOTA upgrade package is used to simultaneously support online upgrade of the software of the two to-be-upgraded versions, namely, the first-version software and the second-version software, to the final-version software by using the wireless network.

8. The method according to claim 7, wherein the method further comprises:
when software of more than two to-be-upgraded versions is comprised, and there are K+2 to-be-upgraded versions, wherein K is a positive integer, generating K+1^{th} transition software according to comparison of file names and binary formats between K+2^{th}-version software and K^{th} transition software, wherein K is the positive integer; and
generating a K+1^{th} FOTA upgrade package according to comparison of file names and file binary formats between the K+1^{th} transition software and the final-version software, wherein the K+1^{th} FOTA upgrade package is used to simultaneously support online upgrade of software of the K+2 to-be-upgraded versions to the final-version software by using the wireless network.

9. An apparatus for generating a FOTA (firmware over the air) upgrade package, comprising:
a first generating unit, configured to generate transition software according to comparison of file names and file binary formats of software of two to-be-upgraded versions; and
a second generating unit, configured to generate a FOTA upgrade package according to comparison of file names and file binary formats between the transition software generated by the first generating unit and final-version software, wherein the FOTA upgrade package is used to simultaneously support online upgrade of the software of the two to-be-upgraded versions to the final-version software by using a wireless network.

10. The apparatus according to claim 9, wherein the first generating unit comprises a first comparing module, a first saving module, and a first generating module, wherein:
the first comparing module is configured to compare the software of the two to-be-upgraded versions;
the first saving module is configured to save files, which have a same file name and are in a same file binary format, as a common file of the transition software; and is further configured to save files, which have different file names or which have a same file name and are in different binary formats, as differentiation files of the transition software; and
the first generating module is configured to generate the transition software according to the common file of the transition software and the differentiation files of the transition software that are saved by the first saving module.

11. The apparatus according to claim 10, wherein the first saving module is specifically configured to:
when the final-version software comprises a file with the same name as the files, in the software of the two to-be-upgraded versions, that have the same file name but are in different binary formats, exclude the files, which have the same file name but are in different binary formats, from the differentiation files of the transition software;
when the final-version software does not comprise a file with the same name as the files, in the software of the two to-be-upgraded versions, that have the same file name but are in different binary formats, retain the files, which have the same file name but are in different binary formats, in the differentiation files of the transition software;
when the software of one to-be-upgraded version has a file excluded from the software of the other to-be-upgraded version, and a file with a same name as the excluded file is comprised in the final-version software, exclude the file from the differentiation files of the transition software; and
when the software of one to-be-upgraded version has a file excluded from the software of the other to-be-upgraded version, and a file with a same name as the excluded file is not comprised in the final-version software, retain the file in the differentiation files of the transition software.

12. The apparatus according to claim 9, wherein the second generating unit comprises a second comparing module, a second saving module, and a second generating module, wherein:
the second comparing module is configured to compare the transition software and the final-version software;
the second saving module is configured to save a file, which is comprised in the final-version software and is not comprised in the transition software generated by the first generating module, as an overwrite file of the FOTA upgrade package; and is further configured to save different parts of the files, which have the same file name but are in different binary formats, as a difference file of the FOTA upgrade package; and
the second generating module is configured to generate the FOTA upgrade package according to the overwrite file and the difference file of the FOTA upgrade package that are saved by the second saving module.

13. The apparatus according to claim 12, wherein:
the second saving module is further configured to save a data of a secure digital memory card of the final-version software as an upgrade file of the FOTA upgrade package; and
correspondingly, the second generating module is specifically configured to generate the FOTA upgrade package according to the upgrade file, the overwrite file, and the difference file of the FOTA upgrade package that are saved by the second saving module.

14. The apparatus according to claim 13, wherein:
the first generating module is further configured to write a file, which is comprised in the transition software and is not comprised in the final-version software, into an upgrade script of the FOTA upgrade package as a to-be-deleted file, so as to delete the to-be-deleted file by using a script command in an upgrade process.

15. The apparatus according to claim 9, wherein when the software of the two to-be-upgraded versions is first-version software and second-version software, the apparatus is specifically configured to:
the first generating unit specifically generates transition software, namely, first transition software, according comparison of the first-version software and the second-version software, and the second generating unit generates a FOTA upgrade package, namely, a first FOTA upgrade package, according to comparison of file names and file binary formats between the first transition software generated by the first generating unit and the final-version software, wherein the first FOTA upgrade package is used to simultaneously support online upgrade of the software of the two to-be-upgraded versions, namely, the first-version software and the second-version software, to the final-version software by using the wireless network.

16. The apparatus according to claim 15, wherein the apparatus is further configured to:
when software of more than two to-be-upgraded versions is comprised, and there are K+2 to-be-upgraded versions, wherein K is a positive integer, the first generating unit is specifically configured to generate K+1^{th} transition software according to comparison of file names and file binary formats between K+2^{th}-version software and K^{th} transition software, wherein K is the positive integer; and
the second generating unit is specifically configured to generate a K+1^{th} FOTA upgrade package according to comparison of file names and file binary formats between the K+1^{th} transition software generated by the first generating unit and the final-version software, wherein the K+1^{th} FOTA upgrade package is used to simultaneously support online upgrade of software of the K+2 to-be-upgraded versions to the final-version software by using the wireless network.

17. A software upgrade method for upgrading software of two to-be-upgraded versions to a final version software, comprising:
acquiring a FOTA (firmware over the air) upgrade package ; and
using the FOTA upgrade package to upgrade a software system of a mobile terminal;
wherein generating the FOTA upgrade package comprises:
generating transition software according to comparison of file names and file binary formats of the software of the two to-be-upgraded versions; and
generating the FOTA upgrade package according to comparison of file names and file binary formats between the transition software and the final-version software, wherein the FOTA upgrade package is used to simultaneously support online upgrade of the software of the two to-be-upgraded versions to the final-version software by using a wireless network.

18. The method according to claim 17, wherein when the FOTA upgrade package comprises an upgrade file, an overwrite file, and a difference file, the upgrading a software system of a mobile terminal specifically comprises:
saving the upgrade file of the FOTA upgrade package as a file, with a same name, of the software system;
saving the overwrite file of the FOTA upgrade package as a file of the software system; and
merging the difference file of the FOTA upgrade package with a same-name file of the software system as a file; and saving the merged file as a same-name file of the software system.

19. The method according to claim 18, wherein the upgrading a software system of a mobile terminal further specifically comprises: deleting, from the software system by using a script command, a to-be-deleted file that is written into an upgrade script of the FOTA upgrade package.

20. A mobile terminal for upgrading software of two to-be-upgraded versions to a final version software, comprising an acquiring unit and an upgrading unit, wherein:
the acquiring unit is configured to acquire a FOTA (firmware over the air) upgrade package; and
the upgrading unit is configured to upgrade a software system of the mobile terminal by using the FOTA upgrade package;
wherein the FOTA upgrade package is generated as following:
generating transition software according to comparison of file names and file binary formats of the software of the two to-be-upgraded versions; and
generating the FOTA upgrade package according to comparison of file names and file binary formats between the transition software and the final-version software, wherein the FOTA upgrade package is used to simultaneously support online upgrade of the software of the two to-be-upgraded versions to the final-version software by using a wireless network.

21. The mobile terminal according to claim 20, wherein the upgrading unit specifically comprises a first saving module, a second saving module, and a third saving module, wherein: when the FOTA upgrade package comprises an upgrade file, an overwrite file, and a difference file, the first saving module saves the upgrade file of the FOTA upgrade package as a file, with a same name, of the software system; the second saving module saves the overwrite file of the FOTA upgrade package as a file of the software system; and the third saving module merges the difference file of the FOTA upgrade package with the same-name file of the software system, and saves a merged file as a same-name file of the software system.

22. The mobile terminal according to claim 21, wherein the upgrading unit further comprises a deleting module, wherein: the deleting module deletes, from the software system by using a script command, a to-be-deleted file that is written into an upgrade script of the FOTA upgrade package.
